(19) United States
(12) Patent Application Publication
(10) Pub. No.: US 2016/0282630 A1
(43) Pub. Date: Sep. 29, 2016

(54) LED LIGHTING DEVICE FOR AN OPERATING FIELD COMPRISING A LIGHT BEAM DIVIDER

(71) Applicant: MAQUET SAS, Ardon (FR)

(72) Inventors: Cécilia VALTEAU, Ligny le Ribault (FR); Minh-Hong VU THUI, Orléans (FR)

(21) Appl. No.: 14/442,681

(22) PCT Filed: Dec. 3, 2013
(86) PCT No.: PCT/FR2013/052918

§ 371 Date: May 13, 2015

(30) Foreign Application Priority Data
Dec. 7, 2012 (FR) 1261765

(51) Int. Cl. G02B 27/10; F21V 23/00; G02B 27/14; F21V 7/08; F21V 13/04; F21S 8/04; F21V 23/02; F21V 5/04

(52) U.S. Cl. CPC G02B 27/1006; F21V 23/02; F21V 23/003; F21V 5/04; F21V 7/08; F21V 13/04; G02B 27/1073; F21S 8/043; G02B 27/144; F21W 2131/205

(57) ABSTRACT

An LED lighting device comprises first and second LEDs arranged to respectively emit first and second beams of white light having first and second different respective colour temperatures, and a beam splitter arranged to split the first and second light beams respectively into a first reflected portion of the first and second beams and a second transmitted portion of the first and second beams. The LED's and the beam splitter are arranged spatially such that the transmitted portion of the first beam and the reflected portion of the second beam overlap into a first resulting beam of intermediate colour temperature between the first and second colour temperatures, and the reflected portion of the first beam and the transmitted portion of the second beam overlap into a second resulting beam of the same intermediate colour temperature.

### TECHNICAL FIELD

The invention relates to a lighting device having light-emitting diodes (LEDs), in particular for a medical lighting fixture for illuminating an operative field.

### PRIOR ART

In a medical environment, and in particular in an operating theater, the lighting conditions should be appropriate for enabling the user, e.g. a surgeon or a physician, to work properly. In particular, the illumination should be as homogeneous as possible so that the user can distinguish between the various types of tissue lying within the field of illumination.

In addition, the illumination, which, overall, is white-light illumination, should comply with certain standards and should produce light have a color rendering index (CRI) lying in the range 85 to 100, and a color temperature lying in the range 3000 Kelvin (K) to 6700 K. The term “color temperature” of the light should be understood herein to mean the equivalent color temperature evaluated in conventional manner on the basis of the (x,y) chromaticity coordinates of the light in a chromaticity diagram of the International Commission on Illumination (CIE).

In addition, it is often desirable for it to be possible for the user to vary certain spectral characteristics of the light, including color temperature, so as to adapt them to suit the user's needs. Ideally, such a variation in spectral characteristics should not be accompanied by any variation in the visual illumination. It should be noted that the light flux of a light source is defined herein as the emitted light power expressed in lumens (lm), and the visual illumination of a lighting device in a field of illumination is defined herein as the quantity of light flux illuminating the field of illumination per unit area expressed in lux, i.e. in lumens per square meter (lm/m²).

Currently, different types of lighting device exist that satisfy these requirements in part and that mix the light coming from a plurality of light sources so as to obtain white-light illumination.

Patent Document EP 2 299 163 discloses a lighting device as described above, in which white LEDs having two distinct color temperatures, namely warm white and cool white, are distributed in alternation around the periphery of a central reflector that focuses the light emitted by the LEDs into the field of illumination. The resulting color temperature of that lighting device may be modified using a plurality of predefined color temperatures. The user thus has access to a limited range of color temperatures. Unfortunately, the beams coming from the two types of LEDs are distinct and the resulting light volume is not homogeneous. In addition, that lighting device suffers from the drawback that, when a user looks at that lighting device, the alternating warm white light and cool white light color temperatures corresponding to the two types of LEDs that are used can be seen, which gives rise to visual discomfort.

There is also Patent Document U.S. Pat. No. 7,465,065, which discloses a lighting device having white and colored LEDs that are juxtaposed to obtain light that is white overall. However, such a device produces light that is not homogeneous, and, with that type of lighting device, when an obstacle masks some fraction of the light flux, e.g. when the user leans under the lighting, the equilibrium between the contributions of the various LEDs is broken, which modifies the color temperature and gives rise to an iridescent effect leading to colored shadows being formed in the operative field.

Patent Document DE 10 2006 040 393 also discloses a lighting device having LEDs, and in which white and colored LEDs forming a “multichip” of LEDs are coupled together to a single focusing system making it possible to obtain white-light illumination that is of adjustable color temperature. In order to improve the mixing of the colors, a light guide is interposed between the multichip of LEDs and the focusing system. However, such a light guide suffers from the drawback of reducing the optical yield of the lighting device because of the technical difficulty of injecting a light flux emitted by a light source into the light guide. Thus, the electrical power consumption of such a lighting device is high. In addition, it is difficult with that type of lighting device to obtain illumination that is homogeneous, and the illumination of the operative field varies as a function of the color temperature chosen by the user. In addition, that type of lighting device suffers from other drawbacks, e.g. the drawback of producing colored shadows in the field of illumination when an obstacle masks some fraction of the light flux.

Document US 2006/0007538 discloses a lighting system in which light beams produced by LEDs of different colors are combined by a polarizing beam splitter. Thus, each beam is split into a transmitted beam and into a reflected beam with orthogonal polarizations. Thus, it is possible to form polarized white light using non-polarized sources, an application for this being to LCD projection, for example.

US 2011/0292343 also discloses an ophthalmic lighting system for white-light illumination that is spectrally augmented with color via one or more cascaded beam splitters.

### SUMMARY OF THE INVENTION

An object of the invention is to remedy those drawbacks by proposing a lighting device offering homogeneous illumination, and high optical yield, without creating colored shadows in the field of illumination, and while allowing the illumination color temperature to be varied.

To this end, the invention provides a lighting device having LEDs for illuminating an operative field, said lighting device comprising a first LED arranged to emit a first white-light beam having a first color temperature, and a second LED arranged to emit a second white-light beam having a second color temperature that is different from said first color temperature, said lighting device being characterized in that it further comprises a beam splitter for splitting said first light beam into a first first beam portion that is reflected by the beam splitter and into a second first beam portion that is transmitted by the beam splitter, and for splitting said second light beam into a first second beam potion that is reflected by the beam splitter and into a second second beam portion that is transmitted by the beam splitter, in that said first LED, said second LED, and said beam splitter are arranged three-dimensionally relative to one another in such a manner that said second first beam portion that is transmitted and said first second beam portion that is reflected are superposed to form a first resulting beam having an intermediate color temperature lying between the first color temperature and the second color temperature, and in such a manner that said first first beam portion that is reflected and said second second beam portion that is transmitted are superposed to form a second resulting beam having said intermediate color temperature, and in that said lighting device further comprises a first optical element arranged to focus said first resulting beam towards a zone of the field of illumination and a second optical element that is arranged to focus said second resulting beam towards said zone.

With such an arrangement, the lighting device having LEDs can thus generate two resulting light beams that are substantially identical, each of which contains a portion of the beam emitted by the first LED and a portion of the beam emitted by the second LED, these two beam portions being superposed, and it being possible for both of the identical resulting beams to be focused towards the same image point in the operative field. The light coming from the LEDs, in particular white light, is thus mixed with theoretical efficiency of 100%, assuming that a beam splitter has a transmission power of 50% and a reflection power of 50%. Resulting white light is thus obtained that has homogeneous illumination and high optical yield.

In addition, in the event an obstacle is present in the field of illumination, no colored shadow is formed in the field of illumination.

The lighting device of the invention may advantageously have the following features:
the lighting device further comprises power supply means for feeding electric current, which means are adapted to feed respective variable currents to said first and second LEDs, and a control unit arranged to control said power supply means in such a manner that the sum of the light fluxes of the of the first and second LEDs remains constant when the magnitudes of said respective currents vary, thereby making it possible, by modulating the current in each of the LEDs appropriately, to obtain the color temperature of the resulting light flux that is desired by the user; it is thus possible to obtain constant illumination and high optical yield over an entire range of color temperatures;
the first light beam emitted by the first LED is substantially perpendicular to said second light beam emitted by the second LED;
the first and second LEDs are disposed at respective distances from said beam splitter that are substantially equal;
the beam splitter may, for example, be a semi-reflective or dichroic mirror having one or two separator faces for separating an incident ray into two light fluxes, one reflected, and the other refracted;
the semi-reflective mirror is inclined at an angle substantially equal to 45° relative to the first and second white-light beams so as to procure a 50% split in the incident ray;
the first and second LEDs are substantially identical from a geometrical point of view, thereby making it easier to obtain homogeneous illumination; in practice, the LEDs have the same packages and the same electronic chips, but the composition of the phosphors forming the diode differs from one LED to the other;
the first optical element may be an elliptical reflector and the second optical element may be a lens;
the elliptical reflector is arranged in such manner than the first LED is positioned at the object focal point of the elliptical reflector, and the zone of the field of illumination is positioned at the image focal point of the elliptical reflector. By means of this arrangement of the device of the invention, the transmitted first beam coming from the first LED is focused at the image focal point, as is the reflected second beam coming from the second LED; given the position of the beam splitter between the two LEDs, the reflected second beam appears to be coming from the first LED, and thus coming from the object focal point, and is therefore focused at the image focal point of the elliptical reflector;
the lighting device may further comprise a third optical element positioned between each LED and the beam splitter, thereby reducing the divergence of the resulting beam. Advantageously, by reducing the divergence of the resulting beam, the illumination area on the first optical element is also reduced, thereby making it possible to reduce the thickness of the lighting device;
the third optical element may be a lens arranged such that the virtual image of the LED is positioned at the object focal point of the elliptical reflector; and
each LED has a color temperature lying in the range 3000 K to 5000 K.

The invention also provides a medical lighting fixture, in particular for illuminating an operative field, said medical lighting fixture including at least one such lighting device.

Advantageously, the medical lighting fixture may further be of the type having a dome in which one or more such lighting devices are included, the lighting dome being open in part, thereby offering the advantage of allowing air to flow in the dome, in particular around the LEDs, around the optical elements, and around the beam splitter.

It is also possible, with such a dome configuration, to use a white LED on one side of the beam splitter and a red LED on the other side in order to improve the color rendering in the red, which is important for distinguishing well between the shades of red in tissue and in blood. The resulting light is then an addition of the white light and of the red light. The color temperature of the resulting light may also be adjusted as indicated above.

### BRIEF DESCRIPTION OF THE DRAWINGS

The present invention can be better understood and other advantages appear on reading the following detailed description of an embodiment given by way of non-limiting example and with reference to the accompanying drawings, in which:

FIG. 1 is a diagrammatic perspective view of a lighting fixture for illuminating an operative field, which fixture incorporates the lighting device of the invention;

FIG. 2 is a highly diagrammatic view showing the principle of the lighting device of the invention;

FIG. 3 is a more detailed diagrammatic view showing the principle of the lighting device of the invention;

FIG. 4 is a graph showing the relationship between current and color temperature in a device of the invention;

FIG. 5 is a highly diagrammatic view of a lighting fixture for illuminating an operative field, which fixture is of the type having a dome incorporating a plurality of lighting devices of the invention; and

FIG. 6 is a diagrammatic view of an example of a support for the LEDs.

### DESCRIPTION OF AN EMBODIMENT

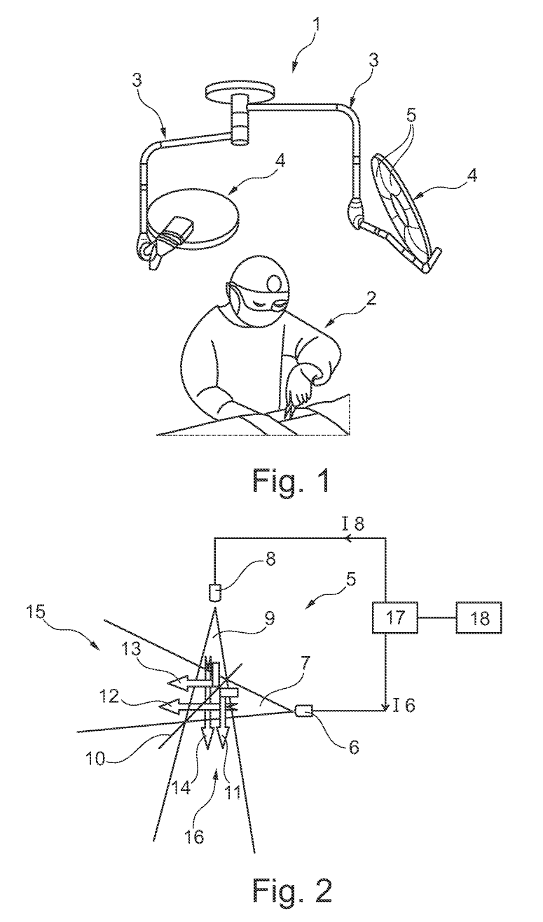

FIG. 1 shows a lighting system 1 for illuminating an operative field of illumination 2, which in this example is an operative field where a surgeon is operating on a patient. In this example, the lighting system 1 is of the type suspended from the ceiling of an operating theater in a manner known per se, and, in the example, it has two articulated suspension arms 3, each of which carries a lighting dome 4 incorporating a plurality of lighting devices 5 of the invention.

FIG. 2 is a diagram showing the principle of a lighting device 5 of the invention that, in this example, comprises a first LED 6 arranged to emit a first beam of white light 7 having a first color temperature Tk1, and a second LED 8 arranged to emit a second beam of white light 9 having a second color temperature Tk2 that is different from said first color temperature.

The lighting device 5 further comprises a beam splitter 10 arranged to split the first white light beam 7 into a first first beam portion 11 that is reflected by the beam splitter 10 and into a second first beam portion 12 that is transmitted or refracted by the beam splitter 10, and to split the second white light beam 9 into a first second beam portion 13 that is reflected by the beam splitter 10 and into a second second beam portion 14 that is transmitted or refracted by the beam splitter 10.

Advantageously, as can be seen in FIG. 2, the first LED 6, the second LED 8, and the beam splitter 10 are arranged three-dimensionally relative to each other in such a manner that the second first beam portion 12 that is transmitted by the beam splitter 10 and the first second beam portion 13 that is reflected by the beam splitter 10 are superposed to form a first resulting white-light beam 15 having an intermediate color temperature Tkr lying between the first color temperature Tk1 and the second color temperature Tk2, and in such a manner that the first first beam portion 11 that is reflected by the beam splitter 10 and the second second beam portion 14 that is transmitted by the beam splitter 10 are superposed to form a second resulting white-light beam 16 identical to the beam 15 and having the same intermediate color temperature Tkr.

In accordance with the invention, and as can be understood from FIG. 2, the lighting device 5 thus makes it possible to generate two resulting light beams 15, 16 that are substantially identical, each of which beams contains light flux coming from the first LED 6 and light flux coming from the second LED 8. Advantageously, the relative arrangement of the LEDs 6, 8 and of the beam splitter 10 superposes the light beams coming from the LEDs 6, 8 in a manner that is close to addition.

A lighting device 5 is thus obtained that produces white light that is very homogeneous, that has an intermediate color temperature, and that has total light flux equal to the sum of the respective light fluxes of the first and second LEDs 6, 8. The light coming from the first and second LEDs 6, 8 is fully mixed without using a light guide or any other optical device that limits optical yield.

The beam splitter 10 should make it possible, on each of two opposite faces, to split a beam with a theoretical yield of 100%, i.e. without any loss, comprising, for example, 50% in reflection and 50% in transmission, or, for example, 30% in reflection and 70% in transmission. It is possible, for example, to use as the beam splitter 10 a high-efficiency dichroic or semi-reflective mirror that is spectrally neutral and that includes a backing plate (made of glass or of a synthetic material) covered with a thin layer of a metal or dielectric compound suitable, on each of two opposite faces, for splitting an incident light beam into reflected flux and refracted flux, the splitting taking place over a spectrum of light intensities or indeed over a spectrum of wavelengths of the incident flux.

In accordance with the invention, and as shown in FIG. 2, the lighting device 5 may further comprise electrical power supply means 17 suitable for feeding currents 16, 18 of respective variable magnitudes in separate manner to the first and second LEDs 6, 8, and a control unit 18 arranged to control the power supply means 17 in such a manner that the total light flux remains constant when the respective currents are varied in the first and second LEDs 6, 8. The intermediate color temperature Tkr of each of the first and second resulting beams 15, 16 can thus vary as a function of the respective feed currents flowing through the first and second LEDs 6, 8, as explained in more detail below.

The electrical power supply means 17 may be in the form of a single electrical power supply or else in the form of two distinct electrical power supply means.

Upstream from the beam splitter 10, each LED 6, 8 may be connected to a cooling radiator, e.g. with thermal grease.

In the example shown in FIG. 2, the second LED 8 is turned through 90° relative to the first LED 6, i.e. the first white-light beam 7 emitted by the first LED 6 is substantially perpendicular to the second white-light beam 9 emitted by the second LED 8. The first and second LEDs 6, 8 are disposed at equal distances from the beam splitter 10 in order to obtain two resulting light beams 16, 15 that are identical in terms of geometry, of light flux and of chromatic homogeneity. FIG. 2 shows the plate of a semi-reflective mirror that is inclined at an angle substantially equal to 45° relative to the axes of the first and second white-light beams 7, 9 in order to make the splitting of the light beams more efficient.

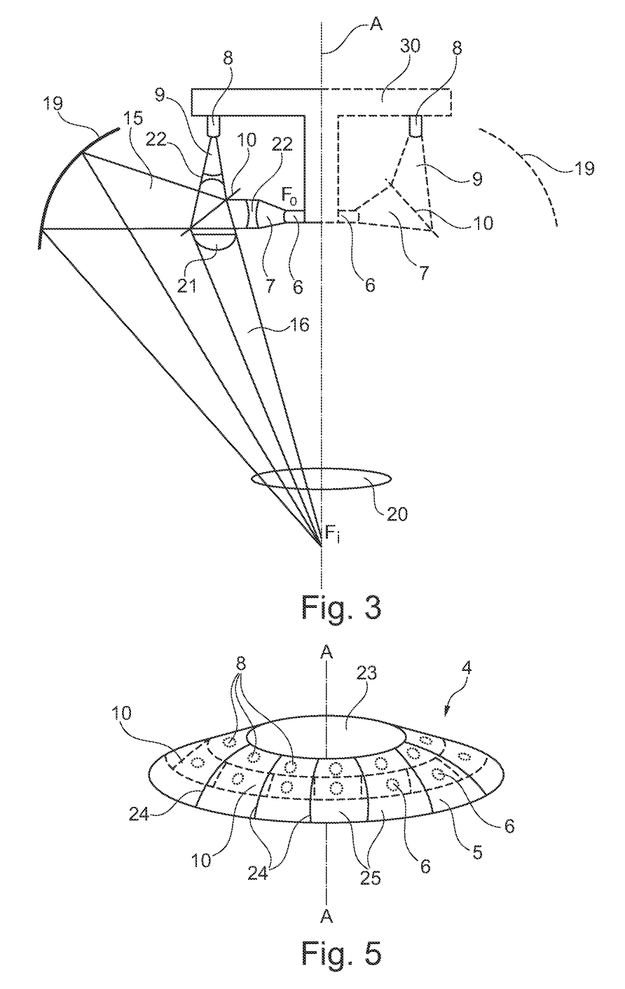

As can be seen in FIG. 3, the lighting device 5 may further comprise an optical element 19 arranged to focus the first resulting beam 15 towards a certain zone 20 of the field of illumination 2, as well as a second optical element 21 arranged to focus the second resulting beam 16 towards the same zone 20. This zone 20 is generally a cylindrical illumination volume having a diameter that may be approximately in the range 10 centimeters (cm) to 30 cm, and having a height that may be in the range 30 cm to 60 cm.

With this arrangement of the lighting device 5, firstly half of the first white-light beam 7 coming from the first LED 6 is transmitted towards the first optical element 19 (second first beam portion 12) and half of it is reflected towards the second optical element 21 (first first beam portion 11), and secondly half of the second white-light beam 9 coming from the second LED 8 is reflected towards the first optical element 19 (first second beam portion 13), and half of it is transmitted towards the second optical element 21 (second second beam portion 14).

In advantageous manner, as shown in FIG. 3, the first optical element 19 is an elliptical reflector arranged in such manner that the first LED 6 is positioned at the object focal point Fₒ of the elliptical reflector 19 and the zone 20 is positioned at the image focal point Fᵢ of the elliptical reflector 19. Advantageously, by means of the arrangement of the first & second LEDs 6, 8, of the beam splitter 10, and of the elliptical reflector 19, all of the rays of the first resulting beam 15 find themselves focused at the image focal point Fᵢ, in the zone 20, i.e. the second first beam portion 12 coming from the first LED 6 and the first second beam portion 13 coming from the second LED 8. The first second beam portion 13 coming from the second LED 8 is reflected by the beam splitter 10 and appears to be coming from the first LED 6, and thus from the object focal point Fₒ, and is therefore also focused at the image focal point Fᵢ in the zone 20.

As can also be seen in FIG. 3, the second optical element 21 is a lens that is placed in the second resulting beam 16 at some distance from the beam splitter 10 so as to focus the rays of the second resulting beam 16 towards the zone 20. Given the geometrical configuration of the first and second LEDs 6 and 8, of the beam splitter 10, and of the second optical element 21, the second second beam portion 14 coming from the second LED 8 finds itself focused at the image focal point Fᵢ in the zone 20, as does the first first beam portion 11 coming from the first LED 6 that is reflected by the beam splitter 10, and that appears to be coming from the second LED 8. It can be understood that the second resulting beam 16 may also be deflected, e.g. by putting a tilt on the outlet face of the lens 21 or indeed by offsetting the lens 21 so that it is off-center relative to the LED. In this example, the two beams 15 and 16 converge at the point Fᵢ in the zone 20 of the operative field.

FIG. 3 shows a third optical element 22 that is positioned between the LED 6 and the beam splitter 10, and also between the LED 8 and the beam splitter 10, and that performs the function of reducing the divergence of the white-light beams 7 and 9. Thus, this optical element 22 makes it possible to achieve a general reduction in the divergence of the resulting beams 15 and 16, and thus in the illumination area on the first optical element 19, thereby making it possible to reduce the thickness of the dome 4. This optical element 22 may be a lens that is arranged in such a manner that the virtual image of the first LED 6 that is created, for example, by said lens, is positioned at the object focal point Fₒ of the first optical element 19. In this manner, the light beam exiting from said lens appears to be coming from the object focal point Fₒ of the first optical element 19 and is therefore focused towards the image focal point Fᵢ of the elliptical reflector 19 in the zone 20. The same applies for the LED 8 with the lens 22.

In order to obtain lighting that is suitable for a medical environment, white LEDs are chosen that are of high color rendering index, lying in the range 85 to 100, and preferably in the range 90 to 100, or indeed lying in the range 95 to 100, and that are of color temperature lying in the range 3000 K to 5000 K. In the example, it is possible to use an LED 6 having a color temperature Tk1 of 3000 K, and an LED 8 having a color temperature Tk2 of 5000 K. White-light illumination is then obtained with an intermediate color temperature Tkr of about 4000 K when currents 16, 18 that are of substantially identical magnitude flow respectively through the first and second LEDs 6, 8, as described in more detail below.

Preferably, the first and second LEDs 6, 8 are chosen to be geometrically identical apart from their color temperature, in order to avoid any difference in light flux between the first and second LEDs 6 and 8 and in order to obtain a homogeneous illumination. The difference between the first and second LEDs may, for example, lie in the composition of the mixtures of phosphor powder that form the LEDs. Preferably, LEDs are chosen that come from the same supplier, having, for example, the same packages and the same electronic chips, and requiring the same type of power supply.

It can thus be understood that, with the same lighting device 5 of the invention that comprises white LEDs only, the presence of an obstacle in the light flux of the lighting device 5 does not create any colored shadow in the operative field 2.

In addition, it is known that the light flux from an LED depends on the magnitude of the current that is passing through it. In accordance with the invention, the control unit 18 is arranged to cause the magnitude of the electric currents 16, 18 passing respectively through the first and second LEDs 6, 8 to vary on the principle of communicating vessels in order to maintain the total light flux constant, so that the illumination in the operative field 2 remains constant while the intermediate color temperature is changing. The term “constant” is used here to mean that the light flux is identical to within 5%.

Thus, the lighting device 5 of the invention produces white light having an intermediate color temperature Tkr that is variable between the first color temperature Tk1 of the LED 6 and the second color temperature Tk2 of the LED 8, at constant illumination, by means merely of appropriate variation in the magnitudes of the respective currents being fed to the first and second LEDs 6 and 8.

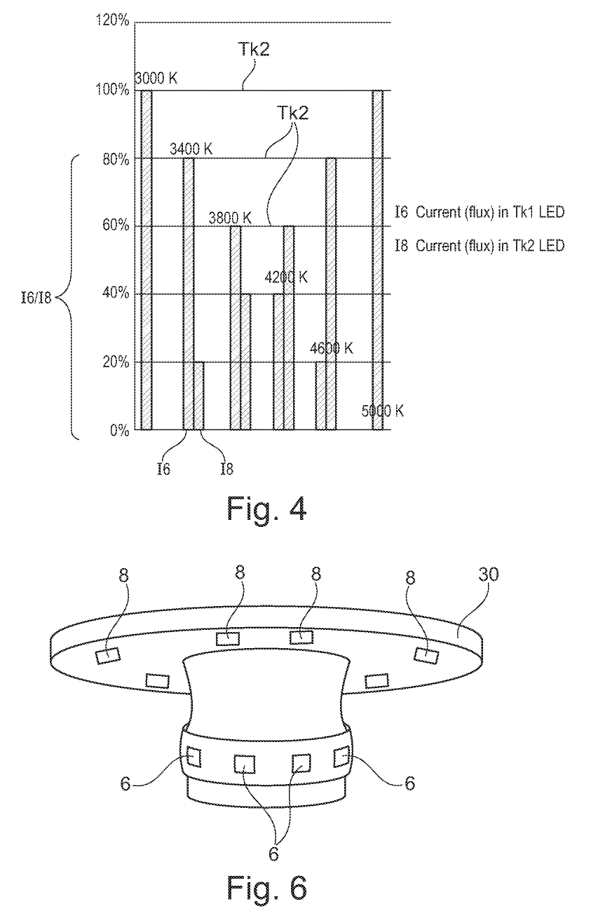

FIG. 4 is a graph that shows various temperatures Tkr of the illumination light from the lighting device 5 that are obtained on the basis of different currents 16, 18 feeding the first and second LEDs 6 and 8 that make it possible to keep the total light flux constant. It can be seen on the graph that the appropriate currents of the first and second LEDs 6, 8 vary on the principle of communicating vessels, i.e. in substantially complementary and opposite manner, while taking account of small corrections. In particular, if the currents for feeding the first and second LEDs 6, 8 are such that the respective light fluxes of the first and second LEDs 6, 8 are equal, then the intermediate color temperature Tkr is one half of the sum of the first and second color temperatures Tk1 and Tk2. If the current of the second LED 8 is zero, then the intermediate color temperature is equal to the first color temperature of the first LED 6. Conversely, if the current of the first LED 6 is zero, then the intermediate color temperature is equal to the second color temperature of the second LED 8. The higher the current passing through the second LED 8 relative to the current passing through the first LED 6, the more the intermediate color temperature tends towards the second color temperature of the second LED 8, and vice versa.

The graph of FIG. 4 was obtained by measuring a spectrum of the light produced by the lighting device 5 with an appropriate sensor, e.g. a spectrometer, and by using that spectrum in conventional manner to evaluate the color temperature of the light produced by the lighting device 5. Calibration is thus constructed for the lighting device 5 that indicates the magnitudes of the feed currents for the LEDs 6 and 8 that are to be supplied in order to obtain a certain intermediate color temperature for the lighting device 5.

Such a sensor, such as a spectrometer, can thus be incorporated into a lighting device 5 of the invention in order to measure the intermediate color temperature Tkr in real time so as to adjust the values for the currents 16, 18 respectively flowing through the first and the second LEDs 6, 8.

It can be seen in FIG. 4 that, with the first and second LEDs 6, 8 having respective color temperatures of 3000 K and 5000 K, it is possible to cause the intermediate color temperature of the lighting device 5 to vary, in stages in this example, between approximately 3000 K and approximately 5000 K.

FIG. 5 is a highly diagrammatic view of a lighting fixture of the dome type that incorporates a plurality of lighting devices 5. In this example, the dome 4 is in the general shape of a hemisphere that is oblate and recessed at its pole 23. It has internal ribs 24 on meridian arcs that are uniformly spaced apart about the axis of revolution A-A of the dome, each rib 24 separating two adjacent lighting devices 5. As shown in FIG. 5, the elliptical reflector 19 of a lighting device 5 is generally constituted on the inside of the dome by panels 25 defined between pairs of adjacent ribs 24 and forming part of an ellipsoid. FIG. 5 also shows the light beam splitters 10 having plates that are plane or that are circularly symmetrical, and also shows the LEDs 6 and 8 that are distributed about the axis A-A.

Advantageously, all of the mirrors 10 that are adjacent in pairs and that are distributed about the axis A-A can be designed as one faceted annular part. Similarly, the elliptical reflectors 19 can also be designed as a single part of annular shape. The power supply 17 and the control unit 18 may advantageously be placed at the pole 23 of the dome without interfering with the optical system per se.

In the light fixture 4, there are as many LEDs 6 as there are LEDs 8. The LEDs 6 and the LEDs 8 are respectively disposed on two concentric rings defined by the outer peripheral edges of a support 30 that, in this example, is of T-section, and that is shown in perspective in FIG. 6 and in axial section in FIG. 3. At the top portion of the T-shape, this support 30 is in the form of a disk carrying the LEDs 8 that illuminate downwards towards the bottom of the T-shape. In addition, at the bottom portion of the T-shape, the support is in the form of a cylinder that is on the same axis as the disk, that is of smaller diameter, and that carries the LEDs 6 that illuminate laterally relative to the T-shape. As shown in FIG. 3, the T-shaped support 30 extends axially along the axis A of the zone 20 of illumination of the operative field. The support 30 can thus also act as a radiator for the LEDs 6 and 8.

Naturally, the present invention is in no way limited to the above description of one of its embodiments, which can undergo modifications without going beyond the ambit of the invention. In particular, depending on the power of the commercially available LEDs and on the desired illumination power, it is possible to choose to mount one or more LEDs 6 and one or more LEDs 8 in each lighting device 5. But the use of a single very powerful LED such as 6 or 8 makes it possible to reduce the area of electronic cards in the lighting device, which offers an economic and ecological advantage. It is also possible to use one white LED 6 and one red LED 8 in order to improve the color rendering index R9.

1. A lighting device having LEDs for illuminating an operative field, said lighting device comprising a first LED arranged to emit a first white-light beam having a first color temperature, and a second LED arranged to emit a second white-light beam having a second color temperature that is different from said first color temperature, said lighting device being characterized in that it further comprises a beam splitter for splitting said first light beam into a first first beam portion that is reflected by the beam splitter and into a second first beam portion that is transmitted by the beam splitter, and for splitting said second light beam into a first second beam portion that is reflected by the beam splitter and into a second second beam portion that is transmitted by the beam splitter, in that said first LED, said second LED, and said beam splitter are arranged three-dimensionally relative to one another in such a manner that said second first beam portion that is transmitted and said first second beam portion that is reflected are superposed to form a first resulting beam having an intermediate color temperature lying between the first color temperature and the second color temperature, and in such a manner that said first first beam portion that is reflected and said second second beam portion that is transmitted are superposed to form a second resulting beam having said intermediate color temperature, and in that said lighting device further comprises a first optical element arranged to focus said first resulting beam towards a zone of the field of illumination and a second optical element that is arranged to focus said second resulting beam towards said zone.

2. A lighting device according to claim 1, further comprising power supply means for feeding electric current, which means are adapted to feed respective variable currents to said first and second LEDs, and a control unit arranged to control said power supply means in such a manner that the sum of the light fluxes of the of the first and second LEDs remains constant when the magnitudes of said respective currents vary.

3. A lighting device according to claim 1, in which said first light beam emitted by said first LED is substantially perpendicular to said second light beam emitted by said second LED.

4. A lighting device according to claim 1, in which said first and second LEDs are disposed at respective distances from said beam splitter that are substantially equal.

5. A lighting device according to claim 1, in which said beam splitter is a semi-reflective mirror.

6. A lighting device according to claim 5, in which said semi-reflective mirror is inclined at an angle substantially equal to 45° relative to said first and second white-light beams.

7. A lighting device according to claim 1, in which said LEDs are substantially identical from a geometrical point of view.

8. A lighting device according to claim 1, in which said first optical element is an elliptical reflector and said second optical element is a lens.

9. A lighting device according to claim 8, in which said elliptical reflector is arranged in such manner than said first LED is positioned at said object focal point (Fₒ) of said elliptical reflector, and said zone is positioned at said image focal point (Fᵢ) of said elliptical reflector.

10. A lighting device according to claim 1, further comprising a third optical element positioned between each LED and said beam splitter.

11. A lighting device according to claim 10, in which said third optical element is a lens arranged such that the virtual image of said LED is positioned at the object focal point (Fₒ) of said elliptical reflector.

12. A lighting device according to claim 1, in which each LED has a color temperature lying in the range 3000 K to 5000 K.

13. A medical lighting fixture, in particular for illuminating an operative field, said medical lighting fixture including at least one lighting device according to claim 1.

14. A fixture according to claim 13, of the type having a lighting dome in which a plurality of lighting devices are disposed about the axis of the dome.
